(19) United States
(12) Patent Application Publication
(10) Pub. No.: US 2012/0043096 A1
(43) Pub. Date: Feb. 23, 2012

(54) Microemulsion Fire Protection Device and Method

(76) Inventors: James R. Butz, Lakewood, CO (US); Thierry Carriere, Littleton, CO (US); Douglas Dierdorf, Los Ranchos de Albuquerque, NM (US)

(21) Appl. No.: 13/044,424

(22) Filed: Mar. 9, 2011

Related U.S. Application Data
(60) Provisional application No. 61/311,982, filed on Mar. 9, 2010.
(60) Provisional application No. 61/441,356, filed on Feb. 10, 2011.
(60) Provisional application No. 61/434,178, filed on Jan. 19, 2011.

(51) Int. Cl. A62C 2/00

(52) U.S. Cl. 169/46; 169/5

(57) ABSTRACT

The present disclosure is directed, in one embodiment, to an exothermic event protection and suppression system comprising exothermic event detectors, suppression system controller, and fire suppression device.

### CROSS REFERENCE TO RELATED APPLICATION

The present application claims the benefits of U.S. Provisional Application Ser. No. 61/311,982, filed Mar. 9, 2010, and 61/441,356, filed Feb. 10, 2011, both entitled “CO2/WATER MICROEMULSION FIRE SUPPRESSION IN DRY BAYS”, and 61/434,178, filed Jan. 19, 2011, entitled “AIMABLE NOZZLE FOR AIRCRAFT FIRE PROTECTION”, each of which is incorporated herein by this reference in its entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. FA9201-09-C-0144 awarded by the United States Air Force.

### FIELD OF THE INVENTION

The disclosure relates generally to detonation, deflagration, and fire protection and suppression technologies and particularly to detonation, deflagration, and fire protection and suppression in confined spaces.

### BACKGROUND

Devices and methods for fire protection, suppression, and/or extinguishment, deflagration protection, suppression, and/or extinguishment, detonation protection, suppression, and/or extinguishment and other exothermic events vary widely in sophistication and components. For example, water alone may effectively suppress or “put out” a flame by lowering the flame temperature and in some situations reduce the concentration of oxygen available for the combustion process. Water removes heat from a fire through phase conversion from water to water vapor and, as water vapor is formed, dilutes the available molecular oxygen to sustain the fire. The high latent heat of vaporization of water absorbs energy from the flame as the water evaporates. Water may also be applied as a water mist to more efficiently lower flame temperature. Chemicals can be used to supplement or replace water and to inhibit or interrupt a fire's combustion processes.

Many trade-offs and design considerations are involved in selecting ingredients and components for fire prevention, suppression, and/or extinguishment. Considerations include cost and weight constraints, space constraints, availability of suppression agents including water and chemicals, reliability, and effectiveness. For example, water is ideally applied to the base of a fire rather than to its perimeter, where it could evaporate prematurely and be unable to displace oxygen. In confined spaces, it can be difficult to adequately supply and direct fire suppression or extinguishing agents, or, in the case of fine water mists, properly generate an effective mist. It may also be difficult to generate timely and effective fire suppression in confined spaces.

To address these challenges halon and/or hydrochlorofluorocarbons (HCFCs) have been developed. Halon has since been banned from use and production under the 1989 Montreal Protocol. Environmentally friendly drop-in replacements for fire suppression systems have been sought, but the search has yielded mixed results in terms of efficacy and volume.

As a result, the quantity of agent to be dispersed to suppress a given fire needs to be increased, leading to tradeoffs between protection on the one hand and weight cost and volume penalties on the other. These tradeoffs are particularly undesirable, by way of illustration, in on-board fires of military aircraft due to impact of projectiles from enemy weapons systems into the confined dry bay area of an aircraft wing. FIGS. 1A-D illustrate the classic dry bay fire/explosion scenario. The wing 60 is divided into two major volumes, a wet wing fuel tank 62 and a dry bay 64 which houses electric wiring and hydraulic lines (FIG. 1A). A projectile 66 penetrates the dry bay 64 and continues into the fuel tank 62 spraying fuel in to the dry bay space 64 (FIG. 1B-C). Hot metal and/or exposed live wires in the dry bay 64 ignites the fuel, leading to fire and possible explosion 68 that disables or destroys the aircraft. Response to such an event must be rapid and effective in order to eliminate or minimize the threat of a fire or explosion. (Note that a breach or penetration of the non-dry-bay area of the wing results in fuel draining or venting to the atmosphere, thereby not resulting in a contained fire hazard). Fire suppression must occur on the order of fractions of a second, not minutes, and must be capable of protecting the immediate vicinity of the penetration as well as surrounding space in the dry bay. There are multiple candidate fire suppression agents for this application, each with advantages and limitations. The agent should be an effective fire suppression medium, with high heat capacity or other mechanism to rapidly extinguish fires.

There is a need for a prevention and suppression system that can effectively and efficiently suppress or prevent fires, detonations, and/or deflagrations, in particular one that does not require halons.

### SUMMARY

These and other needs are addressed by the various embodiments and configurations of the present disclosure. The disclosure is directed to exothermic event detection, prevention, and/or suppression.

In one embodiment, a method includes the steps:
(a) providing a microemulsion comprising first and second exothermic event retardants and a surfactant; and
(b) discharging the microemulsion in a proximity to an exothermic event, whereby the exothermic event is suppressed.
   In another embodiment, an exothermic event suppression device includes:
(a) a storage unit comprising a microemulsion comprising first and second exothermic event retardants and a surfactant; and
(b) a nozzle to discharge the microemulsion in a proximity to an exothermic event, whereby the exothermic event is suppressed.
   The first and second exothermic event retardants are substantially immiscible liquids in the absence of the surfactant. When a containment pressure is substantially released, the first exothermic event retardant is dispersed as liquid droplets and at least most of the second exothermic event retardant converts to a gas.

Fine water mist as combined with microemulsion technology can offer a scalable and adaptable solution for exothermic event suppression and extinguishment. When water is combined with an exothermic event retardant, such as carbon dioxide (CO₂), a rapid and effective capability can be provided. Water has a very high heat capacity per unit weight and can sustain a high rate of heat transfer when deployed as a fine water mist. CO₂ is also an efficient fire suppressant that works by diluting oxygen content to the combustion reaction.

In another embodiment, a system includes:
(a) a plurality of exothermic event detectors to sense an instance of an exothermic event;
(b) an exothermic event locator to locate the sensed exothermic event;
(c) one or more exothermic event suppression devices comprising an exothermic suppression agent and being operable to direct at least one nozzle in a direction of a sensed location of the sensed exothermic event; and
(d) an exothermic suppression system controller operable to direct the exothermic event suppression device to discharge the suppression agent in a direction of the sensed location.
   In another embodiment, an exothermic event suppression device includes:
(a) a nozzle for releasing an exothermic event suppression agent into a defined area;
(b) a directing device to orient the nozzle in a selected orientation; and
(c) an actuating device to release the exothermic event suppression agent into the defined area.

The present disclosure can provide a number of advantages depending on the particular configuration. For example, the disclosed embodiments can initiate exothermic reaction suppression on the order of fractions of a second, not minutes. In one exothermic event suppression agent, water droplets and carbon dioxide behave synergistically to suppress, inhibit or prevent exothermic reactions. In short, the embodiments can extinguish an exothermic event quicker and with less suppression agent than using the conventional total flooding approach. The suppression system can be a lighter-weight, lower-cost local application system to replace total flood clean agent fire suppression systems that are expensive and have operational limitations and environmental concerns.

These and other advantages will be apparent from the disclosure of the invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof refer to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “deflagration” refers to a subsonic combustion that usually propagates through thermal conductivity (for example a hot burning material heats adjacent cold material and ignites it). In a deflagration, the combustion of a combustible gas, or other combustible substance, initiates a chemical reaction that propagates outwardly by transferring heat and/or free radicals to adjacent molecules of the combustible gas. A free radical is any reactive group of atoms containing unpaired electrons, such as OH, H, and CH₃. The transfer of heat and/or free radicals ignites the adjacent molecules. In this manner, the deflagration propagates or expands outwardly through the combustible gas generally at velocities typically ranging from about 0.2 ft/sec to about 20 ft/sec. The heat generated by the deflagration generally can cause a rapid pressure increase in confined areas. Deflagration is different from detonation (which is supersonic and propagates through shock compression).

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “detonation” refers to a supersonic exothermic front that propagates through shock compression. Detonations are observed in both conventional solid and liquid explosives as well as in reactive gases.

The term “emulsion” refers to a mixture of two or more immiscible (unblendable) liquids. Emulsions are part of a more general class of two-phase systems of matter called colloids. Although the terms colloid and emulsion are sometimes used interchangeably, emulsion tends to imply that both the dispersed and the continuous phase are liquid. In an emulsion, one liquid (the dispersed phase) is dispersed in the other (the continuous phase).

The term “explosion” refers to a rapid increase in volume and rapid release of energy, to include detonations and deflagrations.

The term “fire” refers to a rapid, persistent chemical change that releases heat and light and is accompanied by flame, especially the exothermic oxidation of a combustible substance.

The term “exothermic event retardant” refers to any substance that suppresses an exothermic process by one or more of cooling, forming a protective layer, diluting molecular oxygen concentration, chemical reactions in the gas phase, chemical reactions in the solid phase, char formation, and/or intumescents.

The term “microemulsion” refers to a thermodynamically stable single-phase fluid formed by the dispersion of droplets of one phase into a second phase and stabilized by a surfactant. In contrast to ordinary emulsions, microemulsions commonly form upon simple mixing of the components and do not require high shear conditions. Typical microemulsions consist of a stable, isotropic liquid mixture of oil, water and a surfactant, frequently in combination with a cosurfactant. The aqueous phase may contain salt(s) and/or other ingredients, and the “oil” may actually be a complex mixture of different hydrocarbons and olefins. Two basic types of such microemulsions are direct (oil dispersed in water, o/w) and reversed (water dispersed in oil, w/o). Microemulsions may also be formed with non “oil” components, e.g., CO₂. Thus microemulsion includes, for example, water-in-CO₂ (WIC) and CO₂-in-water (C/W) microemulsions.

The term “module” refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The term “surfactant” refers to compounds that lower the surface tension of a liquid, the interfacial tension between two liquids, or that between a liquid and a solid. Surfactants may act as detergents, wetting agents, emulsifiers, foaming agents, and dispersants. Commonly, the tail of the surfactant is a hydrocarbon chain (e.g., an aromatic hydrocarbon (arene), an alkalne (alkyl), alkenes, cycloalkanes, or alkyne-based), an alkyl ether chain (e.g., ethoxylated or propoxylated surfactant), a fluorocarbon chain (e.g., a fluorosurfactant), and a siloxane chain (e.g., a siloxane surfactant), and the head can be nonionic (having no charge) or ionic (carrying a net charge). The head can be anionic (e.g., based on permanent anions such as sulfate, sulfonate, phosphate or pH-dependent anions such as carboxylate), cationic (e.g., based on pH-dependent primary, secondary, or tertiary amines or permanently charted quaternary ammonium cations), zwitterionic (e.g., based on primary, secondary, or tertiary amines or quaternary ammonium cation with sulfonates, carboxylates, or phosphates), or nonionic (e.g., fatty alcohols, polyoxyethylene glycol, polyoxypropylene glycol, glucoside alkyl ethers, polyoxyethylene glycol alkylphenol ethers, glycerol alkyl esters, polyoxyethylene glycol alkylphenol ethers, glycerol alkyl esters, polyoxyethylene glycol sorbitan alkyl esters, sorbitan alkyl esters, cocamide MEA or DEA, dodecyldimethylamine oxide, and block copolymers of polyethylene glycol and polyprylene glycol. In the case of ionic surfactants, the counter-ion can be monoatomic or polyatomic.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

FIG. 1A depicts a fire suppression scenario involving the dry bay area of an aircraft wing, wherein the wing and dry bay are in their undamaged, nominal state;

FIG. 1B depicts a fire suppression scenario involving the dry bay area of an aircraft wing wherein a projectile enters the dry bay area;

FIG. 1C depicts a fire suppression scenario involving the dry bay area of an aircraft wing wherein a projectile continues through the dry bay into the fuel area resulting in a spray of fuel into the dry bay;

FIG. 1D depicts a fire suppression scenario involving the dry bay area of an aircraft wing wherein the projectile has caused an explosion in the wing;

FIG. 2 depicts the system block diagram of the invention;

FIG. 3 depicts an embodiment of the agent storage container containing a water/CO₂ agent invention that addresses the fire suppression scenario of FIG. 1;

FIG. 4A depicts an embodiment of the invention that addresses the fire suppression scenario of FIG. 1;

FIG. 4B depicts an embodiment of the agent storage container as a tube array container;

FIG. 4C depicts an embodiment of the agent storage container as a wound composite container;

FIG. 4D depicts an embodiment of the agent storage container as a stackable, modular array of containers with container strap plates;

FIG. 4E depicts a cross-sectional view of the embodiment of the agent storage containers of FIG. 4D;

FIG. 5 depicts an embodiment of the fire suppression system in a confined area;

FIG. 6A depicts an embodiment of the fire suppression system of FIG. 5 with combined fire detection and fire suppression;

FIG. 6B depicts a cross-sectional view of the embodiment of the fire suppression system of FIG. 6A just below the Actuation Device Pin;

FIG. 6C depicts a cross-sectional view of an alternate embodiment of the plate 55 of FIG. 6A;

FIG. 7 depicts an embodiment of the steering coils of FIG. 6; and

FIG. 8 depicts a flowchart according to an embodiment.

### DETAILED DESCRIPTION

Embodiments of the disclosure are directed to systems and methods for suppression, extinguishment, retardation, and/or prevention of exothermic events, such as fires, deflagrations, and detonations. As used herein, “exothermic event” refers to any exothermic event, including without limitation fires, detonations, and deflagrations, and also to the creation or presence of conditions conducive to a fire, detonation, or deflagration, and “exothermic event suppression” refers to exothermic event prevention, inhibition, extinguishment, termination, retardation, and/or cessation.

### Microemulsion Exothermic Event Prevention

In one embodiment, a microemulsion exothermic event suppression agent is provided.

The microemulsion exothermic event suppression agent comprises at least first and second, commonly immiscible, fluid (typically liquid-phase) components, a surfactant, and other optional additives. The surfactant renders the first and second fluid components miscible. While not wishing to be bound by any theory, it is believed that one end of the surfactant attaches to the first component and the other end to the second component.

The first component is commonly water, ammonia, another liquid phase exothermic reaction retardant, and mixtures thereof. Water has a relatively high heat capacity per unit weight and can sustain a high rate of heat transfer when deployed as a fine water mist with mean, median, and D_{V90} (diameter where 90% by volume of the droplets are of this size or smaller) droplet sizes commonly less than about 100 microns, even more commonly less than about 50 microns, and even more commonly ranges from about 10 to about 30 microns. As discussed in detail below, the fine water mist is formed when a containment pressure of the microemulsion is released.

The second component is any substance that is primarily a liquid under the containment pressure and primarily a gas when the pressure is released. This combination is significant in that the second component serves multiple functions: it pressurizes the mixture to expel it from a storage container, it enhances the atomization of the first component in the formation of a fine mist, it provides momentum to propel a fine mist of the first component towards an identified exothermic event in a protected area via expansion in the gas phase, and finally the second component can itself be an effective exothermic event retardant. The second component is normally carbon dioxide, trifluoromethane (CHF₃), fluoroform, carbon trifluoride, methyl trifluoride, fluoryl, Freon 23, Arcton 1™, HFC 23, FE-13™, FM-200TH, HFC-134a, HCFC-22, aminomethane or methylamine, Novec™, other haloforms or halogens, bromotrifluoromethane (CBrF₃), monobromotrifluoromethane, trifluoromethyl bromide, bromofluoroform, carbon monobromide trifluoride, halon 1301, BTM, Freon 13BI, Freon FE 1301, Halon 1301 BTM, bromomethane (CH₃Br) also known as methyl bromide, monobromomethane, methyl fume, Halon 1001, Curafume, Embafume, UN 1062, Embafume, Terabol, PFC-410, CEA-410, C₃F₈ (PFC-218 or CEA-308), HCFC Blend A (NAF S-III), HFC-23 (FE 13), HFC-227ea (FM 200), IG-01 (argon), IG-55 (argonite), HFC-125, HFC-134a, Aerosol C, CF₃I, HCFC-22, HCFC-124, HFC-125, HFC-134a, trifluoroethane, gelled halocarbon/dry chemical suspension (PGA), propane, sulfur dioxide, and non-halogenated hydrocarbons, such as methane, halomethanes, and/or a refrigerant. Exemplary refrigerants include those having the ASHRAE numbers R-11, R-12, R-12B1, R-12B2, R-13, R-13B1, R-22, R-22B1, R-23, R-40, R-134, R-407A, R-407B, R-407C, R-410A, R-410B, and mixtures thereof. Carbon dioxide is preferred as it is an efficient fire suppressant that works by diluting molecular oxygen vapor pressure and cooling to the exothermic reaction.

The surfactant can be any surfactant rendering the first and second components substantially miscible. The surfactant is believed to modify the surface properties of the first and/or second components, thereby forming the emulsion, or a substantially homogeneous solution. Typically, the surfactant is a nonionic surfactant.

An optional additive includes any freezing point depressant to retard or prevent freezing (such as an aircraft operating at cruise altitude, or spacecraft operating in space). An exemplary freezing point depressant is methanol, ethylene glycol, propylene glycol, and other glycols, an alkali metal acetate, a salt, other colligative agent, any other antifreeze that is substantially inflammable, and mixtures thereof.

Another optional additive is a one or more of a dry powder (e.g., sodium chloride, copper-based powders, and graphite-based powders), dry chemical (e.g., monoammonium phosphate, sodium bicarbonate, potassium bicarbonate, urea complex, and sodium carbonate), and/or wet chemical (e.g., potassium acetate, potassium carbonate, or potassium citrate).

Another optional additive is a pH adjustor. pH can have a dramatic effect on microemulsion stability. Simply adding carbon dioxide, for instance, to water can form carbonic acid, resulting in a pH shift of the solution before emulsion to about pH 3. By the addition of small amounts of base to the mixture, pH can be adjusted. Commonly, the pH of the microemulsion ranges from about pH 3 to about pH 7 and even more commonly from about pH 4 to about pH 7.

In one formulation, the first and second fluid components include water (a polar molecule) and carbon dioxide (a nonpolar molecule), respectively.

The microemulsion typically contains from about 5 to about 95 wt. %, even more typically from about 10 to about 90 wt. %, and even more typically from about 25 to about 75 wt. % of the first fluid component; from about 5 to about 95 wt. %, even more typically from about 10 to about 90 wt. %, and even more typically from about 25 to about 75 wt. % of the second fluid component; no more than about 10 wt. %, more typically from about 0.1 to about 5 wt. %, and even more typically from about 0.1 to about 3 wt. % surfactant, and no more than about 10 wt. %, more typically no more than about 7.5 wt. %, and even more typically no more than about 5 wt. % of one or more other additives. Stated another way, the molar ratio of the first and second components typically ranges from about 1:10 to about 10:1, even more typically from about 1:5 to about 5:1, and even more typically from about 1:3 to about 3:1.

The first and second fluid components are normally present in the microemulsion as droplets. The microemulsion is typically stored in a storage unit under pressure. To maintain carbon dioxide as a liquid at ambient temperature, the pressure in the microemulsion should be maintained at a value above the saturation equilibrium. The storage unit can be made of any material having sufficient tensile strength to resist the internal pressure of the microemulsion. The pressure is sufficient to maintain the second component in the liquid phase. Typically, the pressure is at least about 500 psig, more typically ranges from about 800 to about 1070 psig, and even more typically ranges from about 825 to about 875 psig. As can be seen, the containment or storage pressure is much higher than ambient pressure, which is typically the pressure external to the container and at the location of the exothermic event.

The pressure can be released, and the exothermic suppression agent released into the defined area, in any suitable manner. For example, the pressure may be released and exothermic suppression agent released by opening a valve, by puncturing the storage unit, by mechanically or chemically, rupturing the storage unit (e.g., by puncturing the storage unit with a projectile or other object, by contacting the storage unit with a chemical solution that reacts with, and removes, a portion of the storage unit, and the like). Whatever technique is used to rupture the storage unit, the rupture should happen in a controllable and rapid manner. In one configuration, the valve is spring loaded for rapid valve opening.

The storage unit can be any composition sufficient to withstand the internal storage pressure of the microemulsion. Examples of suitable storage units include metal containers, plastic containers, composite containers, ceramic, and combinations and composites thereof.

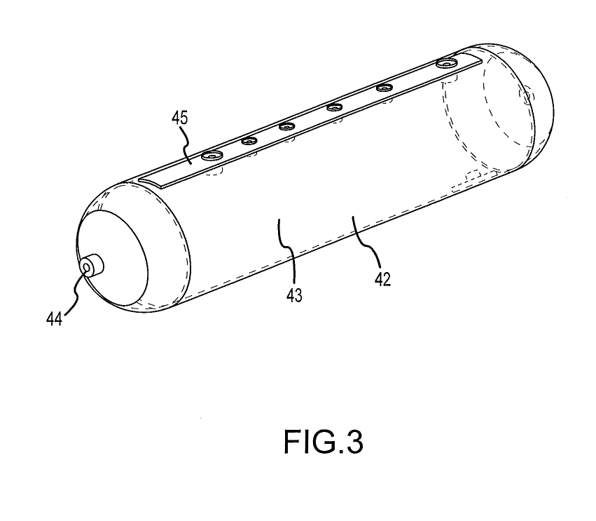

FIG. 3 presents one embodiment of a composite shell embodiment of a suppression agent storage container 42. This embodiment is particularly useful in a confined space, such as in a confined space of an aircraft, ship, or other type of vehicle, e.g., the cargo hold, avionics and electronics bay, hydraulic actuator and/or hydraulic tank holding area, galley, and cockpit instrumentation and display area, and other areas where fuel is stored in confined spaces to include the fuselage-portion of an aircraft.

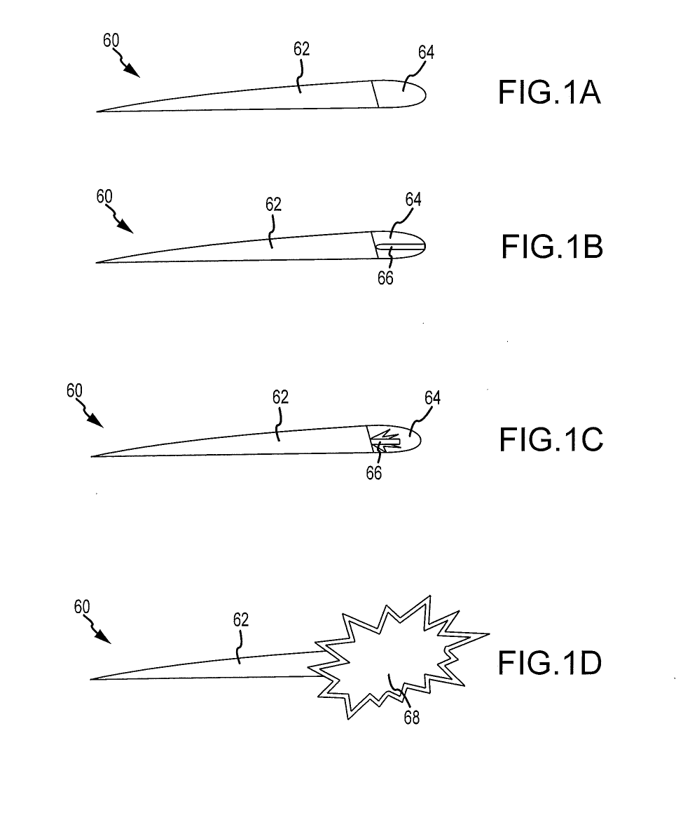

In one configuration, the storage container 42 is a fiber reinforced polymer (FRP) composite pressure vessel. The agent storage container 42 features could include a composite shell, a metal polar boss 44 and port assemblies 45 as necessary. The polar boss 44 is an area at one or more ends of the agent storage container 42 that is not made of FRP, for example composed of metal. The polar boss 44 provides an interface to the agents 43 stored within the storage container 42, for example, an interface to pressure lines that communicate with an additional supply of agent 43 and fill the storage container 42 with agent 43. The port assemblies 45 provide an alternative or complementary means of discharging the agent 43 held within the storage container 42, in that the port assemblies 45 provide one or more holes through which agent 43 may be discharged. The port assemblies 45 may be used in an embodiment of the invention wherein agent 43 is actively released, rather than passively released such as upon penetration of the storage container 42 by a projectile 66 (as depicted in FIGS. 1A-D).

In other embodiments, the storage container 42 uses other types of pressure vessels, for example, Types I, II, III, IV or V. Type Pressure vessels are categorized by type and range from Type I, all metal pressure vessels, to Type V, all FRP-composite. Other pressure vessel types include a metal tank featuring FRP composite layers oriented in the hoop direction (i.e., Type II), an FRP composite tank featuring a metal liner (i.e., Type III), and an FRP composite tank featuring a polymer liner (i.e., Type IV).

The storage container 42 is particularly useful in an exothermic suppression system appropriate for a tightly confined area, such as the dry bay scenario of FIGS. 1A-D, wherein the storage container is fitted in the dry area of the wing. When configured to address the dry bay scenario of FIGS. 1A-D, the storage container 42 is designed to distribute the storage volume over most, if not all, of the vulnerable area in a dry bay 64. A projectile 66 that penetrates the dry bay 64 and enters an adjacent fuel tank 62 would rupture the storage container 42 as well. Since the microemulsion is substantially uniform throughout, at any temperature and pressure, it flows to the newly-created hole in the container, where at least most of the second component (e.g., CO₂) flashes to the gas phase while at least most of the first component remains in the liquid phase. The gas phase of the second component assists in the atomization of the first component (e.g., fine water mist). For example, a change in CO₂ volume by over three orders of magnitude fractures adjacent water droplets in the emulsion into a fine water mist that is well-suited for exothermic event suppression. In addition, the expanding CO₂ plume disperses the fine water mist throughout the protected dry-bay space.

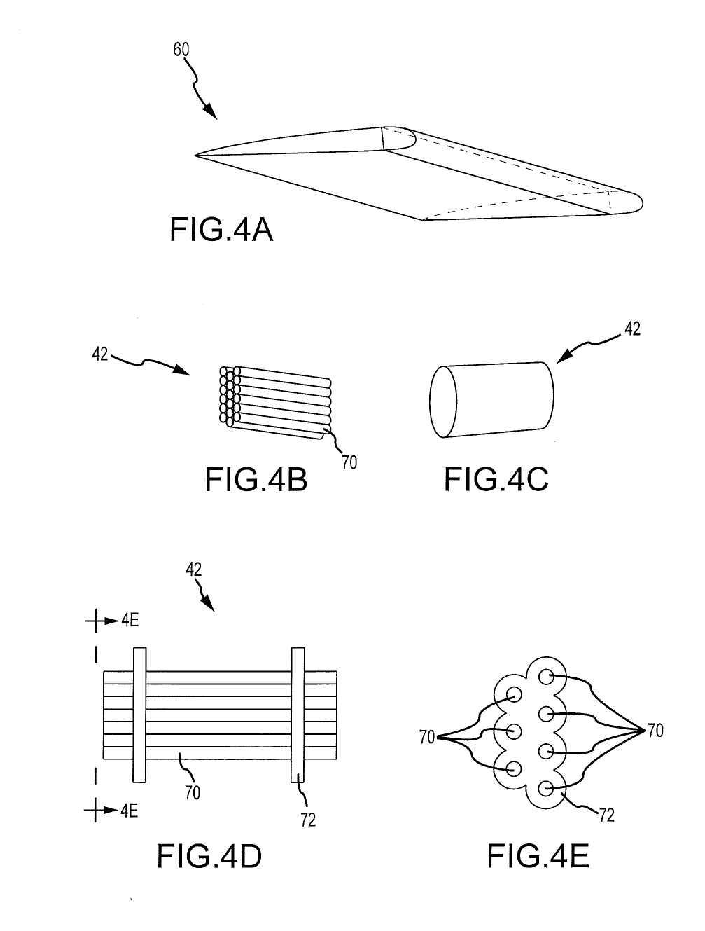

In another embodiment, a plurality of storage containers is provided. A tube array arrangement 70, as shown in FIG. 4B, rests each storage container 42 upon others (in one configuration each container being similar to that of FIG. 3). In another configuration, segments of tubing can be manifolded to provide a capacity to respond to multiple projectiles at different times and locations in the dry bay 64. FIG. 4D presents a configuration of storage containers 42 as an array of containers 72, wherein the containers 42 are modular and, although stacked as in FIG. 4B, are also separated by container strap plates 72 configured to allow the containers to stack in an off-set manner. The container strap plates 72 allow more overall wing dry bay volume 64 to be covered yet still enable at least one storage container 42 to be penetrated by a projectile 66 entering the dry bay 64. The embodiment of the array of containers 70 of FIGS. 4D-4E would be particularly useful when the system 10 is implemented in difficult to access locations or those prone to damage, such as the internal cavities or bays of aircraft. The storage containers of FIGS. 4B and 4D-4E may or may not be in fluid communication with one another. The embodiments of FIG. 4B-E present a system activated in a passive fashion, such as by a puncture of a storage container 42 by an external source. For example, upon an explosive charge 66 shot through the dry bay area 64, the storage container 42 directly emits exothermic event suppression agent 43 without use of any active actuation device. However, in other embodiments of the invention, the embodiments of the storage container 42 as shown in FIGS. 4B-E are implemented in an active or controlled system 10.

In one configuration, each of the storage containers 42 of FIGS. 4B and 4D is a small-diameter flexible tubing capable of accommodating the storage pressure of the microemulsion. The tubing can be fabricated from high-performance plastic, such as polyetheretherketone (PEEK), and is flexible enough to follow contours in the dry bay space. As a projectile penetrates the tubing sheet, the fractured tubes become release points and de-facto nozzles through which the microemulsion is expelled to the immediate vicinity of the dry bay compartment to suppress any exothermic event that is initiated. By manifolding the tubing at each end, the entire contents of the tubing array may be discharged when any tube is ruptured.

In another embodiment of the invention, the storage container 42 is fabricated as a wound composite (FIG. 4C). For this design, an oval-shaped fiber-wound configuration is used, fabricated to an appropriate length and installed on the dry bay 64 wall adjacent to the fuel tank 62. When ruptured, the entire microemulsion contents of the container 42 would be discharged into the protected space. The fiber wound container can, for example, be graphite or kevlar fibers spiral wound around a metal container and coated with an epoxy cured at a suitable temperature. The storage container embodiments of FIGS. 4B and 4D could also be fabricated as a wound composite.

### Exothermic Event Suppression System

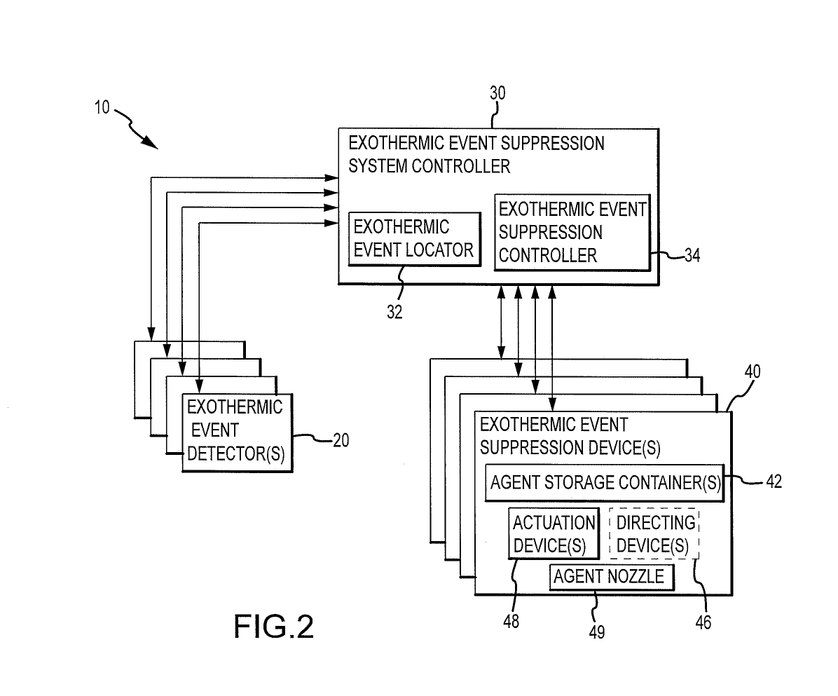

Referring to FIG. 2, an exothermic event suppression system 10 is shown, which is comprised of one or more exothermic event detectors 20, an exothermic event suppression system controller 30, an exothermic event locator 32, an exothermic suppression controller 34, one or more exothermic event suppression devices 40, one or more exothermic event suppression agent storage container(s) 42, one or more actuation devices 48, and one or more optional directing devices 46 and one or more agent nozzles 49. Although the exothermic event suppression system 10 is depicted containing all of these components, one or more components may be eliminated or combined in some applications and/or embodiments of the invention.

The one or more exothermic event detectors 20 (also referred to herein as “detectors”) may be of one or several types, such as thermal detectors, optical detectors to include photo-detectors, infrared, ultra-violet or any specific wavebands, motion detectors, hot-wire anemometers, or any detectors that may be used to detect an exothermic event. In embodiments of the invention, the detectors 20 may be omni-directional or directional, may be operated continuously or discontinuously, and may be configured as an array. Further, the detectors 20 may be digital or analog, and optionally require a power source. The detectors 20 are configured to be in communication with the exothermic event suppression system controller 30. This communication may be through electrical, electro-mechanical, hydraulic, pneumatic, thermal, radioactivity, ionization, photo detectors, or other communication means, and could be wireless. In a preferred embodiment, the detectors 20 provide an electrical signal to the exothermic event suppression system controller 30. In a preferred embodiment, the detectors 20 are configured to provide a complete field of view of the area to be protected.

The exothermic event suppression system controller 30 (also referred to herein as “system controller”) provides overall system control of the exothermic event suppression system 10, to include control of the controllers of exothermic event locator 32 and exothermic event suppression controller 34. Generally, the system controller 30 receives inputs from the fire detectors 20, interprets and processes the signals, and outputs signals to the exothermic event suppression devices 40. In one preferred embodiment, the system controller 30 functions to determine the exothermic event location, through the exothermic event locator 32, and to control the exothermic event suppression devices 40 through the exothermic event suppression controller 34. Each of the system controller 30, exothermic event locator 32 and the exothermic event suppression controller 34 utilize control logic. More specifically, these controllers may use any variety of control law logic, to include state estimation, stochastic signal processing, deterministic control, adaptive control, and combinations of proportional-integral-derivative (PID) control. Further, each of the controllers 32, 34 and 30 may utilize first-received or strongest-received, comparative, template matching, pattern matching, or threshold control techniques.

The exothermic event locator 32 (also referred to herein as “event locator”) provides location information for the exothermic event or events of interest. More specifically, the event locator takes as input the signals from the detectors 20 and outputs positional data as to the location of the exothermic event. The event locator 32 may determine the location of the event by combining the signals received from the detectors 20 in any of several ways, depending on the number and type of detectors 20 implemented and the relative weighting and emphasis the event locator places onto each type and number of detectors 20. For example, in one embodiment utilizing three or more thermal detectors, the event locator may take the strongest signal received from a particular thermal detector and identify the event as co-located at that particular thermal detector. In other embodiments, the event locator uses template matching, first-received or strongest-received sensed signal, comparative signal strengths, template matching, threshold control and/or pattern matching techniques. Alternately or in combination, the event locator could proportionally weigh the value or strength of the multiple signals received (where a higher value indicates greater thermal energy) to calculate a vectored position to the exothermic event. Triangulation may be employed to locate the exothermic event based on signals received from three or more detectors. In another embodiment, wherein the detectors are cameras, the strongest pixel in a frame is used to identify the angle from the camera to the event, therein determining the exothermic event location. In another embodiment involving multiple thermal detectors, a positional state estimation model for an exothermic event is formulated, that, using the input measurements from multiple thermal sensors, allows the positional state of an exothermic event to be determined. In other embodiments the detectors 20 form an array of off-the-shelf photo-detectors arranged in such a way to have a complete field of view of the enclosure to be protected. The pixel from the detector 20 within the array with the highest immediate infrared or visible light response would be identified by one or more of controllers 32, 34, or 30 and the approximate location of the exothermic event would then be determined.

The exothermic event suppression controller 34 (also referred to herein as “suppression controller”) receives the identified location of the exothermic event from the event locator 32 and outputs signals to the exothermic event suppression device 40. The suppression controller 34 sends commands to the exothermic event suppression device 40 that may direct all or some of the storage containers 42, actuation devices 48, and/or steering devices 46, and/or agent nozzles 49. In a preferred embodiment, the suppression controller 34 receives an electrical signal from the event locator 32 that identifies the position of the exothermic event. The suppression controller 34 then calculates a preferred combination, timing, volume, pressure and other character of exothermic event suppression agents 43 as stored in the storage containers 42 to direct, through the directing devices 46, to the exothermic event and then sends electrical commands to selected ones or all of the exothermic event suppression device(s) 40, each of which in turn actuates the actuation devices 48 to deliver exothermic event suppression agent through nozzles 49 to the exothermic event. The commands received by and sent from the suppression system controller 30, and received by and sent to the exothermic event suppression device 40 may be any communication means, to include electrical, electro-mechanical, hydraulic, pneumatic, and thermal means.

The exothermic event suppression system controller 30, locator 32, and suppression controller 34 are typically implemented as processor executable logic stored on a computer readable medium or media.

The one or more fire suppression devices 40 (also referred to herein as “suppression devices”) are used to prevent, suppress and/or extinguish an exothermic event. The suppression devices 40 may include agent storage containers 42 (also referred to herein as “storage containers”), exothermic event suppression agents (also referred to herein as “agents”), actuation devices 48, directing devices 46, and agent nozzles 49.

The agent storage containers 42 may be of any size and configuration appropriate for the exothermic event suppression agent stored and for the environment of the exothermic event suppression system 10. The storage container 42 must be able to withstand pressures that maintain a liquid state of the agents. A higher-pressure container generally requires greater wall thickness and thus generally is heavier, a disadvantage in some applications, such as in the aviation dry bay example of FIG. 1. The container 42 must maintain enough pressure to enable the agent 43 to rapidly and effectively disperse the agent 43 as an aerosol particle formation or fine water mist. In some embodiments, aerosol particle size is in the range from 20 micron and 50 micron. In one embodiment, the storage container 42 is designed to enable and maintain pressures imparted to the agents of between 250 psi and 3,000 psi. An aerosol is a suspension of fine solid particles or liquid droplets in a gas.

Any one or multiple exothermic event retardant(s) can be used as the exothermic event suppression agent depending on the configuration and operational environment of the suppression system 10. Candidate agents each have advantages and limitations. Embodiments of the present invention combine multiple agents with complementary features.

Although many of the embodiments are described with reference to microemulsion and/or fine water mist suppression agents, it should be noted that embodiments of the disclosure are not limited to these retardant agents. For example, embodiments may employ any technique of emulsion dispersion, any colloid system involving two-phase systems including hydrocolloids, addition of emulsifiers, and other combinations of ingredients, including powders, applicable for fire extinguishment or suppression. In other formulations, other exothermic event retardant agents, which may be used alone or in combination with a microemulsion or one another include dry powders (e.g., sodium chloride, copper-based powders, and graphite-based powders), dry chemicals (e.g., monoammonium phosphate, sodium bicarbonate, potassium bicarbonate, urea complex, and sodium carbonate), foams (such as aqueous film forming foam, alcohol-resistant aqueous film forming foams, film foaming fluoroprotein, compressed air foam system, Arctic Fire™, FireAde™, and the like), water (e.g., air pressurized water and fine water mist), wet chemicals (e.g., potassium acetate, potassium carbonate, or potassium citrate), wetting agents (e.g., detergents), antifreeze, clean agents (e.g., carbon dioxide, inert gas (e.g., inergen and argonite), Novec 1230™, and Halotron FE-36), and halon (e.g., halon 1211 and 1301).

The actuation devices 48 may be mechanical, chemical, electrical, electromechanical, or electrochemical in nature. The actuation device 48 may be effected by any reliable type of means employed for rapid actuation. For example, the actuation device can be a valve, a puncture device, a projectile, a latch, an acidic solution, an electrically destroyed component, or combinations thereof. In one configuration, the actuation device 48 includes explosive charges, bolts, pins, or projectiles or bolts, pins or projectiles spring-loaded so as to impart a puncture force upon the storage container and thereby discharge the agent 43 from the storage container 42. In other configurations, the actuation device 48 employs electromagnetics, magnetic flux fields, stationary magnets, hydraulics, pneumatics, linear or variable differential transducers, ultrasonics including ultrasonic piezo drives, and/or piezo-electric transducers. In other configurations, the actuation device 48 uses a pre-scored disc or structure on the storage container 42, which is readily and rapidly punctured through, for example, a spring-loaded pin.

In one configuration, the actuation device 48 comprises a puncture or projectile mechanism. The actuating devices 48 are fired, or actuated, upon a control signal from the exothermic event suppression system controller 30.

In another configuration, the actuation devices 48 selectively activate or discharge agents 43 in one or more agent storage containers 42, or actuate or discharge all of the storage containers 42.

The actuating device 48 can be of many different configurations. The actuating device can be a motor, electromagnetic conductor outputting an electrical or magnetic field, magnet, valve, fluidics, hydraulics, pneumatics, or other unit for selectively energizing selected agent nozzles 49 of the corresponding exothermic event suppression device 40 and/or for steering a selected nozzle or subset of nozzles into position to release the exothermic suppression agent in the direction of the sensed exothermic event. In some configurations, the actuating device 48 uses a motion control technology such as electromagnetics, magnetic flux fields, stationary magnets, hydraulics, pneumatics, linear or variable differential transducers, ultrasonics including ultrasonic piezo drives, and piezo-electric transducers. One configuration uses a pre-scored disc or structure on the storage container 42 which is readily and rapidly punctured through, for example, a spring-loaded pin.

The agent nozzles 49 can be any suitable discharge device. The agent nozzle 49 (herein also referred to as “nozzle”) could be steerable, configured to control discharge volume, and/or purely geometrical without active control. In one configuration, the nozzle of U.S. Pat. No. 5,495,893, which is incorporated herein by this reference, is employed. In one configuration, the nozzle of U.S. Pat. No. 5,597,044, which is incorporated herein by this reference, is used. In another configuration, the nozzle of co-pending U.S. patent application Ser. No. 11/875,494, which is incorporated by this reference, is used.

The suppression devices 40 may not include all components as shown in FIG. 2, for example, the suppression device may not include any directing devices and/or actuation devices, and rather, simply emit agents directly from one or more storage containers 42. Also, the fire suppression devices 40 may combine elements as shown in FIG. 2, for example, the directing devices 46 and actuation device 48 and agent nozzles 49 may be combined.

In alternate embodiments of the invention, combinations of components of the exothermic event suppression system 10 may form embodiments, for example, the detectors 20 and directing devices 46 may be combined into one physical unit. In one embodiment, the steering device 46 is integrated with the nozzle 49 to form one component. Similarly, in other embodiments, other components may be combined, for example the steering device 46 and actuation device 48. In the various combinations, the impact of gravity on discharge time and quality should be minimal so the system can be effective in any conditions.

In an embodiment using water-in-CO₂ microemulsions, the suppression system 10 approximately locates an exothermic event and aims, directs, or steers deployment of exothermic retardant from a storage container 42 via a directing device 46, then discharges a highly effective two-phase mixture 43 of a fine mist of the water and CO₂ gas directly at the exothermic event. In this manner, it is possible to extinguish an exothermic event more quickly and with less retardant than using the conventional total flooding approach. This can result in an effective suppression system 10 that is generally lighter and smaller than current hardware while providing superior fire protection. In this embodiment, a uniform fluid in the extinguisher is generated so that lack of gravity (e.g., in space missions) would not impact extinguisher performance.

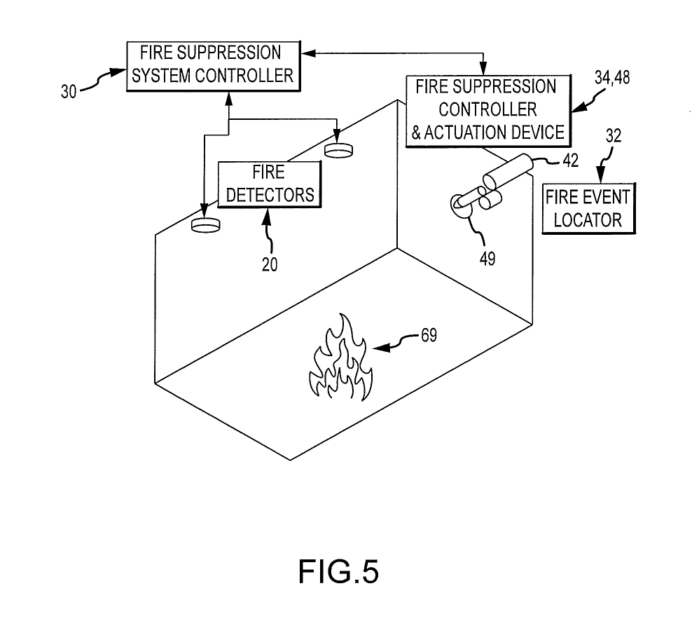

FIG. 5 is an embodiment of the exothermic event suppression system 10 of FIG. 2 in a confined area. In this embodiment, the exothermic event is a fire and the suppression system 10 features two detectors 20, which provide detection signals to suppression controller 30. The suppression controller 30 receives the detection signals, interprets the signals and, through one or more techniques disclosed above, sends commands or control signals to a combined suppression controller 34 and actuation device 48. The combined suppression controller 34 and actuation device 48 in turn communicate with an agent storage container 42, an event locator 32, and nozzle 49, to emit suppression agent into the confined area to suppress and/or extinguish the fire.

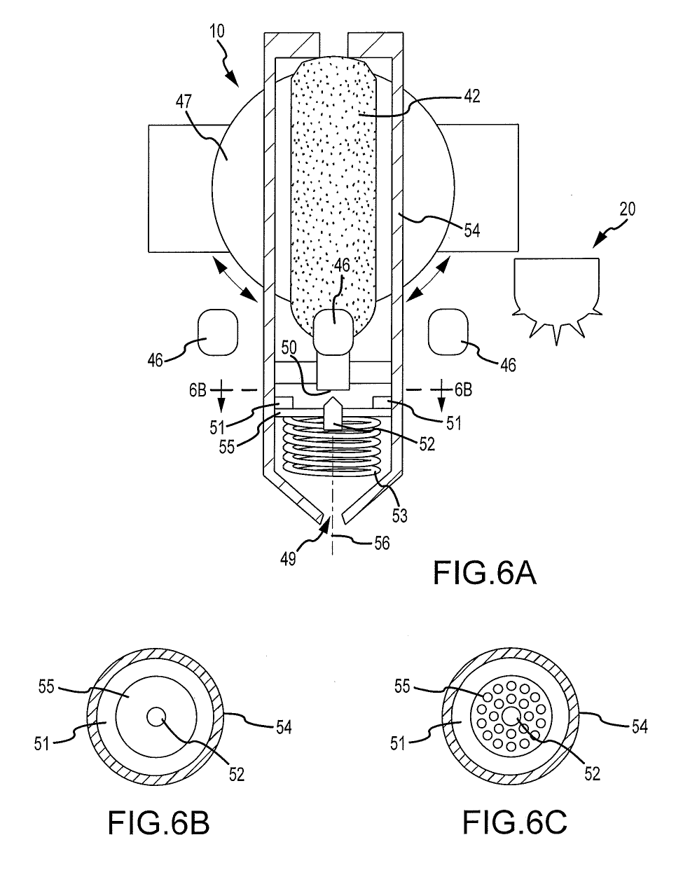

FIGS. 6A-C and 7 depict an embodiment of the suppression system 10 of FIG. 5 with combined exothermic event detection 20 and suppression devices 40 and aimable nozzle 49. This embodiment offers the ability to sense the location of an exothermic event, direct and discharge (within a 100 ms window) a spray of suppression agent at an angle of 15 degree or more in relation to the exothermic event while keeping weight and moving parts to a minimum.

The four main components of the suppression system 10 of FIGS. 6A-C and 7 are: a set of fire detectors 20, typically configured as an optical exothermic event location sensor array, a suppression agent storage container 42 contained within a housing 45 having a nozzle 49, a plurality of directing or steering devices 46 positioned around the container 42 and housing 45 and, in one configuration, configured as a set of steering coils (electromagnets), and a fast discharge actuation device 48. The fast discharge actuation device 48 includes a burst disc 50, a sharp pin 52 and squib 51 mounted on a movable plate 55, and a compressed spring member 53 engaging the housing 54 and movable plate 55. The pin 52 is axially aligned with the burst disc 50 to effect puncture of the disc 50 in response to the force of the spring member 53. The squib 51 engages the housing 54 and moveable plate 55 to hold the plate 55 in a stationary (disengaged) position. In another embodiment, the agent storage container 42 serves as all or part of the housing 54.

This arrangement can enable the nozzle's direction of suppression agent 43 discharge to be oriented at a significant offset from the longitudinal axis 56 of the housing 54 when in the nominal central nozzle position (of FIGS. 6A-C and 7). The off-axis angle relative to the longitudinal axis 56 of the housing 54 is typically at least about 5 degrees, more typically at least about 10 degrees, and even more typically at least about 15 degrees.

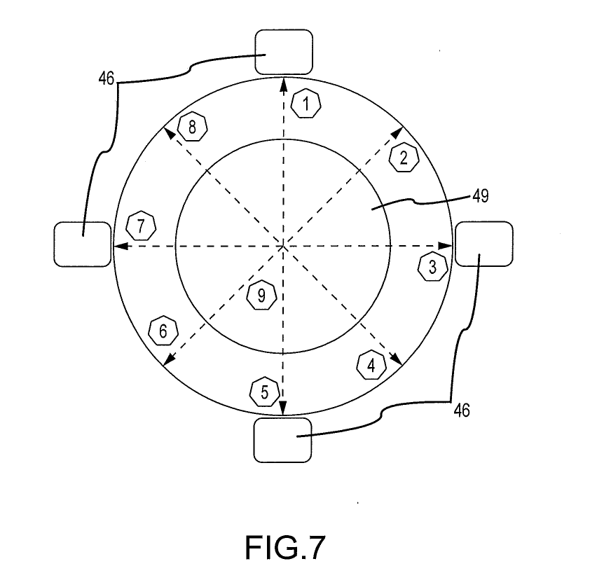

The system 10 will operate in the following manner. In response to receipt of a fire alarm signal from the rapid-response fire detector 20 or fire suppression system controller 30, the sensor array 20 (which in one configuration is an array of off-the-shelf photo detectors arranged in such a way to have a complete field of view of the three-dimensional volume to be protected) is queried by event locator 32. The detector 20 array pixel with the highest immediate infrared or visible light response would be identified by controller 32 and the approximate location of the exothermic event then determined. This control information is processed by controller 32 and a control signal sent so that a selected one or more of the steering devices 46 is energized or de-energized to attract or move the nozzle 49 off-axis in the direction of the exothermic event. If, for instance, four steering devices 46 configured as coils are installed for the steering device 46, a total of nine discrete nozzle 49 positions are available, as shown in FIG. 7 (remain on-center, four when one coil energized, and four others when two adjacent coils are energized). The nozzle 49 is movable to the desired position and/or orientation via a gimbal head 47. As a result, the nozzle 49 is moved so that it points in the approximate direction of the exothermic event. In one configuration, the steering devices 46 repel the housing when energized. In that configuration, the steering devices 46 are all energized to maintain the nozzle on-center and one or more are de-energized to move the nozzle 49 to a desired position and/or orientation. In another embodiment, the communication and/or control functions of the event locator 32 regarding the sensor array 70 are handled by one or more of the system controller 30, event locator 32, and/or suppression controller 34.

Simultaneous to the steering or aiming action, the movable plate 55 is released by destruction of the squib 51 and no longer maintained in a disengaged position. When released, the spring member 53 forcibly displaces the movable plate 55 towards the burst disc 50, to move the movable plate 55 to an engaged position, causing the pin 52 to puncture the burst disc 50. The internal pressure of the stored suppression agent 43 forces the suppression agent 43 to be forcibly released and pass at a high velocity through the burst disc 50, pass around or through holes (not shown) in the movable plate 55, and through the nozzle 49. In one embodiment, the moveable plate 55 is designed and configured to spring-against the housing 54 and/or to be expelled from the housing 54 so as to not interfere with the discharge of the suppression agent 43 through the nozzle 49. In another embodiment, the plate 55 is configured with one or more holes to enable agent 43 to pass through nozzle 49 (FIG. 6C). The expelled suppression agent 43 contacts the exothermic event, such as the fire or detonation or deflagration wavefront, thereby suppressing the exothermic event.

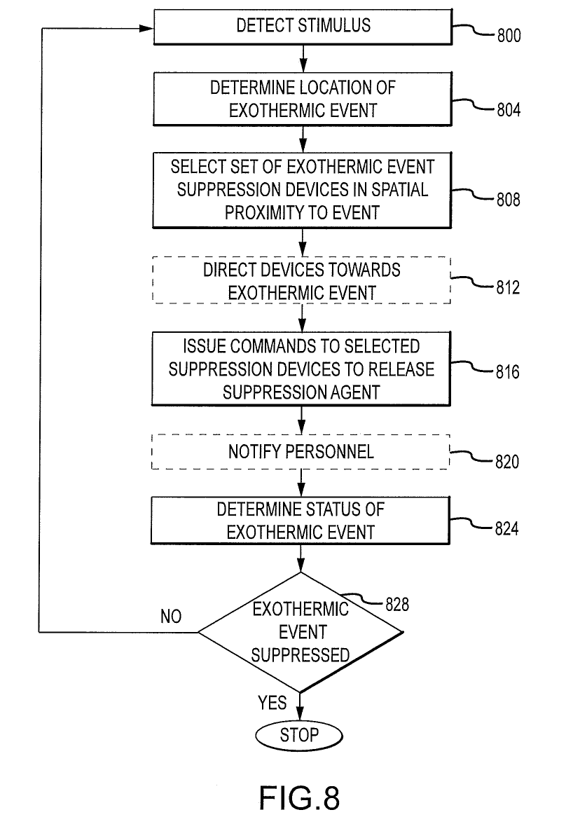

An operational embodiment of the suppression system 10 will now be described with reference to FIG. 8.

In step 800, the system controller 30 and/or suppression controller 34 detects a stimulus indicative of an instance of an exothermic event. The stimulus can be, for example, a signal from one or more of the exothermic event detector(s) 20.

In step 804, the system controller 30 and/or suppression controller 34 queries the event locator 32 for a location of the detected instance of the exothermic event. The query may include the unique identifier of the reporting event detector(s) 20 from step 800. The event locator 32 pulls or the detector(s) 20 push sensed information to the event locator 32. A comparator or other function determines exothermic event location as discussed above. For instance, the comparator logic can compare one or more received sensed information against selected thresholds, one another, and/or a predetermined template or pattern to identify those detectors in spatial proximity to the exothermic event. Other location techniques, such as triangulation may then be used to locate more precisely the exothermic event.

Once the location is determined, the system controller 30 and/or suppression controller 34, in step 808, is able to selected a subset of exothermic event suppression devices 40 in spatial proximity to the determined exothermic event location.

In optional step 812, the system controller 30 and/or suppression controller 34 transmits appropriate control signals to the selected subset of suppression devices 40 to orient or aim the devices 40 towards the determined exothermic event location.

In step 816, the system controller 30 and/or suppression controller 34 issues commands to the selected subset of suppression devices 40 to release their respective suppression agent. Typically, the commands are issued substantially simultaneously to maximize the effectiveness of the released agent.

In optional step 820, the system controller 30 and/or suppression controller 34 notifies appropriate personnel, which may include governmental fire emergency personnel.

In step 824, the system controller 30 and/or suppression controller 34 requests the exothermic event locator 32 to determine a status of the exothermic event using a technique described above.

In decision diamond 828, the system controller 30 and/or suppression controller 34, based on a response from the event locator 32, determines whether the exothermic event is suppressed. If not, the suppression controller 34 returns to and repeats step 804 if there is surplus agent 43 remaining or agent 43 was replaced. If so, the suppression controller 34 terminates operation in step 832 until a next stimulus instance is detected.

### EXPERIMENTAL

The following examples are provided to illustrate certain embodiments and are not to be construed as limitations on the disclosure, as set forth in the appended claims. All parts and percentages are by weight unless otherwise specified.

A series of experiments were performed to provide an aircraft dry-bay-area fire-suppression system that addresses the scenario of FIGS. 1A-D. A consideration for such a suppression system is its mass efficiency. The commonly accepted metric for evaluating this mass efficiency is the system mass per unit volume of protected dry-bay-area in units of pounds-per-cubic-foot. For example, a U.S. Air Force requirement cites a maximum threshold of 2 pounds-per-cubic-foot for an advanced dry-bay-area fire-suppression system. For reference, this corresponds to the lower end of the density range for rigid dry-bay foams, an early technique adopted for suppressing fire in aircraft dry-bays. Based on fire suppression performance of the fine water mist (FWM) fire suppression, an analysis of the mass efficiency of the FWM microemulsion technology was performed. Live-fire tests were performed using a mass of FWM agent ranging from 120 to 20 g. In each case, fire suppression/inhibition was successfully achieved. Note that the representative dry-bay volume was a constant 0.5 ft3 for each test.

To fully evaluate the mass efficiency of the present FWM fire suppression technology, an analysis of the FWM agent containment/delivery packaged was performed. A schematic of a fiber reinforced polymer (FRP) composite pressure vessel is provided in FIG. 3 with important design features noted including the composite shell, the metal polar boss 44 and port assemblies 45, if necessary. The use of FRP as the material for pressure vessels has many benefits, most notably their lower specific properties as compared to metals and their combination of a high degree of anisotropy and design tailor-ability.

Pressure vessels are categorized by type and range from Type I, all metal pressure vessels, to Type V, all FRP-composite. Other pressure vessel types include a metal tank featuring FRP composite layers oriented in the hoop direction (i.e., Type II), an FRP composite tank featuring a metal liner (i.e., Type III) and an FRP composite tank featuring a polymer liner (i.e., Type IV). As expected, mass efficiency increases with increasing pressure. The rate of mass savings for a tank design decreases with increasing Type. To identify preliminary conceptual designs, a Netting Analysis technique commonly used in designing composite pressure vessels was used. This analytical approach establishes the relationship between the stresses resulting in the composite plies of the pressure vessel and the internal pressure, material properties and processing parameters. It assumes that all loads are supported by the fibers only and neglects any contribution from the polymer matrix material and the interaction between fibers. These assumptions do not cause any significant error in the analysis, as long as the fibers are primarily loaded in tension and the transverse and shear stresses in the composite plies are low compared to the ultimate tensile strength of the fibers. It is also assumed that the load sharing contribution from the liner is minimal or non-existent.

This analysis was performed for two pressure vessel cases: 1) an aluminum lined FRP pressure vessel and 2) a polymer-lined FRP pressure vessel. The results are also provided in terms of the ratio of the tank-to agent mass. Key assumptions for this analysis include an 48-inch tank length, standard modulus carbon fiber at 0.60 fiber volume fraction, spherical dome, 2400 psi burst pressure (i.e., factor of safety of 3 based on an 800 psi service pressure) with a 25%-increase mark-up in resulting mass to account for the metal boss and associated hardware. Note the tank radius sensitivity at small radii that is due to the increased effect of the mass of the tank dome, boss and hardware on the overall system mass. This indicates from a mass efficiency perspective a preference for larger radius tanks.

The final step in the analysis is to incorporate the tank liner and agent mass to obtain a complete system mass and compare it to the volume of protected aircraft dry-bay area. The analysis was performed based on four different coverage cases that correspond to the select results from the live-fire tests. Coverage is defined as the mass of agent required to protect a given volume of dry-bay (i.e., lbs/ft³). These include:
Coverage A: 20 g test or, 0.088 lbs/ft³
Coverage B: 50 g test or, 0.22 lbs/ft³
Coverage C: 80 g test or, 0.35 lbs/ft³
Coverage D: 120 g test or, 0.53 lbs/ft³

The results indicate that a polymer-lined FRP tank has a high degree of likelihood in surpassing the Air Force requirement at tank radii as low as 1-inch. It is assumed that the rate of increase of the ratio of system mass to protected dry-bay volume accelerates considerably at tank radii less than 1-inch, again due to the variation in scaling effects between the composite shell and composite dome and boss and hardware. Again, this indicates a design preference for larger tank radii based on mass efficiency. The results for the aluminum-lined tank case reveal that a preferred tank radius greater than 3-inches is required to exceed the Air Force requirement.

In other experiments, a test fixture was developed in which a pressurized container of CO₂/water microemulsion was positioned in front of a gasoline container to be impacted by a high-speed armor-piercing bullet. This arrangement simulated a kinetic penetrator entering a dry bay space on a combat aircraft protected by the CO₂/water microemulsion fire suppression system 10. The test fixture was fitted with a nichrome wire heated to cherry-red condition to present an ignition source in the dry bay space. A pressure transducer was also installed to measure pressure changes in the space due to fires and/or fire suppression. Fires were consistently started in the test fixture without the presence of the pressure unit and when the pressure unit remained empty of microemulsion. The first live-fire test with agent was run with a pressure unit containing 120 g of microemulsion, and no fire was observed. This result was confirmed in a replicate test. In subsequent tests the quantity of microemulsion was routinely reduced upon successful prevention of fire. In fact, review of the high-speed video records indicated that rather than suppressing fires, the release of the microemulsion was instead preventing (inhibiting) them, believed to be due to the presence of CO₂ and fine water mist generated in the dry bay compartment upon rupture of the pressure unit by the 0.30-06 bullet. That is, despite the presence of a fuel plume and an ignition source in the form of a glowing-red nichrome wire, no ignition of the fuel/air mixture occurred. For all six tests run with microemulsion in the pressure unit, no fires were observed. Contents of the pressure unit ranged from 120 grams microemulsion down to 20 grams. The high-speed video records showed no ignition; it appeared that the CO₂ and water mist generated upon rupture of the pressure unit filled the dry bay space and prevented any combustible mixture of fuel and air from being formed. The fire tests demonstrated the ability to deliver up to 120 g of microemulsion from the storage container in less than 60 milliseconds, well within target military specifications.

Microemulsions of water-in-CO₂ over a range of mass fractions from 30% CO₂ to 70% CO₂ were proven to be effective exothermic event suppression agents. Further, four different surfactants, namely BASF L61™ (a difunctional block copolymer terminating in a primary hydroxyl group), BASF L92™ (a difunctional block copolymer terminating in a primary hydroxyl group), GE-Silicone Silwet L-7622™ (polyakyleneoxide modified polydimethylsiloxane copolymer surfactant), and DuPont Zonyl FSO-100™ (a sparingly water-soluble, ethoxylated nonionic fluorosurfactant), have been evaluated, with their concentrations varied from 0.5% to 2% to investigate the impact of surfactant concentration on microemulsion stability. Microemulsions have been demonstrated which incorporated potassium acetate as an additive to reduce the freezing point of the microemulsion to −18° C. Stable microemulsions were subsequently used in live-fire tests to evaluate their efficacy in extinguishing fires in a simulated dry bay space (i.e., the scenario of FIG. 1).

Therefore, in summary, an embodiment of the invention that uses a full FWM fire suppression system for aircraft dry-bay protection meets or exceeds the Air Force's requirement of 2 lbs/ft³ of system-mass-to-protected-dry-bay-volume. For maximum mass efficiency, this embodiment assumes an FRP composite tank as the FWM agent containment vessel. However, embodiments of the invention may employ either an aluminum-lined or a polymer-lined tank design for the agent storage container 43. Further, other embodiments use off-the-shelf storage containers 43. Further, commercial off-the-shelf hydraulic tubing is a viable option for deployment in the dry bays of combat aircraft.

A number of variations and modifications of the disclosure can be used. It would be possible to provide for some features of the disclosure without providing others.

For example embodiments of the disclosure are modular in the sense that one or more components may be removed or combined depending on the particular application and operational environment encountered. For example, in one embodiment, the exothermic event suppression system does not utilize an array of sensors and/or artificial intelligence and is passive in that, upon an external triggering event, the system automatically responds and emits an exothermic event suppressant. Generally, embodiments of the exothermic event suppression system disclosed herein include one or more exothermic event detectors used to detect an exothermic event, one or more exothermic event devices containing one or more exothermic event suppression agents, and an exothermic suppression system controller used to locate the exothermic event and activate and control the operation and/or direction of exothermic event suppression devices.

Embodiments of the disclosure are not limited to confined spaces, but rather are applicable to non-confined spaces to include open volumes or spaces. For those embodiments configured for use in confined spaces, those confined spaces include the dry bay area of aircraft wings, aircraft engine nacelles and vehicle engine compartments, flammable liquid storage spaces, protection of computer rooms and electronics, and military ground vehicle fire protection in cab and crew areas. Applications include transportation (e.g. trains, boats, cargo) and sensitive spaces (e.g. laboratories, server rooms).

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
providing a microemulsion comprising first and second exothermic event retardants and a surfactant; and
discharging the microemulsion in proximity to an exothermic event, whereby the exothermic event is suppressed.

2. The method of claim 1, wherein the first and second exothermic event retardants are substantially immiscible liquids in the absence of the surfactant and wherein, when a containment pressure is substantially released, the first exothermic event retardant is dispersed as liquid droplets and at least most of the second exothermic event retardant converts to a gas.

3. The method of claim 2, wherein at least one of a mean, median, and D_{V90} droplet size of the first exothermic event retardant is less than about 100 microns and wherein the containment pressure is at least about 150 psi.

4. The method of claim 1, wherein the first exothermic event retardant is one or more of water, ammonia, HFC, and HCFCs and wherein the microemulsion comprises from about 10 to about 90 wt. % of the first exothermic event retardant.

5. The method of claim 1, wherein the second exothermic event retardant is one or more of carbon dioxide, Fe-13, N₂, arsonite, Inerfen, and mixtures thereof and wherein the microemulsion comprises from about 10 to about 90 wt. % of the second exothermic event retardant.

6. The method of claim 1, wherein the surfactant is nonionic and wherein the microemulsion comprises from about 0.1 to about 10 wt. % surfactant.

7. The method of claim 1, wherein, in the microemulsion, a molar ratio of the first and second exothermic event retardants ranges from about 1:10 to about 10:1.

8. An exothermic suppression device, comprising:
a storage unit comprising a microemulsion comprising first and second exothermic event retardants and a surfactant; and
a nozzle to discharge the microemulsion in a proximity to an exothermic event, whereby the exothermic event is suppressed.

9. The device of claim 8, wherein the first and second exothermic event retardants are substantially immiscible liquids in the absence of the surfactant and wherein, when a containment pressure is substantially released, the first exothermic event retardant is dispersed as liquid droplets and at least most of the second exothermic event retardant converts to a gas.

10. The device of claim 9, wherein at least one of a mean, median, and D_{V90} droplet size of the first exothermic event retardant is less than about 100 microns and wherein the containment pressure is at least about 150 psi.

11. The device of claim 8, wherein the first exothermic event retardant is one or more of water, ammonia, HFC, and HCFCs and wherein the microemulsion comprises from about 10 to about 90 wt. % of the first exothermic event retardant.

12. The device of claim 8, wherein the second exothermic event retardant is one or more of carbon dioxide, Fe-13, N₂, arsonite, Inerfen, and mixtures thereof and wherein the microemulsion comprises from about 10 to about 90 wt. % of the second exothermic event retardant.

13. The device of claim 8, wherein the surfactant is nonionic and wherein the microemulsion comprises from about 0.1 to about 10 wt. % surfactant.

14. The device of claim 8, wherein, in the microemulsion, a molar ratio of the first and second exothermic event retardants ranges from about 1:10 to about 10:1.

15. A system, comprising:
a plurality of exothermic event detectors to sense an instance of an exothermic event;
an exothermic event locator to locate the sensed exothermic event;
at least one exothermic event suppression device comprising an exothermic suppression agent and being operable to direct at least one nozzle in a direction of a sensed location of the sensed exothermic event; and
an exothermic suppression system controller operable to direct the at least one exothermic event suppression device to discharge the suppression agent in a direction of the sensed location.

16. The system of claim 15, wherein the at least one exothermic event suppression device moves at least one nozzle to orient the at least one nozzle in a direction of the sensed exothermic event location.

17. The system of claim 15, wherein the at least one exothermic event suppression device selectively expels an exothermic suppression agent through a first nozzle but not a second nozzle, the first nozzle being oriented in a direction of the sensed exothermic event location and the second nozzle not being oriented in a direction of the sensed exothermic event location.

18. The system of claim 15, wherein the suppression agent is a microemulsion of first and second exothermic event retardants and a surfactant.

19. An exothermic event suppression device, comprising:
a nozzle for releasing an exothermic event suppression agent into a defined area;
a directing device to orient the nozzle in a selected orientation; and
an actuating device to release the exothermic event suppression agent into the defined volume.

20. The device of claim 19, wherein the directing device comprises at least one of a motor, an electric field, a magnetic field, a pressurized hydraulic fluid, and a pneumatic gas.

21. The device of claim 19, wherein the suppression agent is a microemulsion of first and second exothermic event retardants and a surfactant.
